(19) United States
(12) Patent Application Publication
(10) Pub. No.: US 2017/0262543 A1
(43) Pub. Date: Sep. 14, 2017

(54) METHOD AND SYSTEM FOR IMPROVING SESSIONS AND OPEN FILES ENUMERATIONS BY DATA STRUCTURES CHANGES

(71) Applicant: Dell Products L.P., Round Rock, TX (US)

(72) Inventors: Ohad GERZI, Kadima (IL); Dina Fine, Herzlia (IL)

(21) Appl. No.: 15/065,152

(22) Filed: Mar. 9, 2016

(51) Int. Cl. G06F 17/30

(52) U.S. Cl. CPC G06F 17/30867; G06F 17/30126; G06F 17/30203

(57) ABSTRACT

A method and a system for carrying out filtered enumeration of files and session in a file system are provided herein. The method may include: receiving a filtered enumeration request from a client machine at a file system server, the file system server comprises a distributed cluster of nodes, wherein the filtered enumeration request indicates subsets of sessions and files metadata associated with the file system server; applying the filtered enumeration request to each of the nodes; aggregating the subsets sessions and files metadata of the filtered enumeration request, to create an aggregated filtered enumeration of the sessions and the files metadata; and transmitting the aggregated enumeration of the sessions and the files metadata to the client machine.

### FIELD OF THE INVENTION

The present invention relates generally to the field of storage, and more particularly to distributed shared files systems.

### BACKGROUND OF THE INVENTION

FIG. 1 is a block diagram illustrating non-limiting exemplary architecture of a distributed file system 100 implementing a Network Attached Storage (NAS) in accordance with the prior art. Distributed file server 120 may include a plurality of nodes (aka controllers) 130-1 to 130-x connected to a bus 180 operating in Internet Small Computer Systems Interface (iSCSI), a fiber channel (FC) or the like.

Bus 180 connects distributed file server 120 to a plurality of block storage devices 190 possibly configured as a part of a Storage Area Network (SAN) device aligned, for example, in a Redundant Array of Independent Disks (RAID) configuration.

Each of nodes 130-1 to 130-x may include a central processing unit (CPU) 160-1 to 160-x respectively, and memory units 150-1 to 150-x respectively, on which several processes are being executed. Nodes 130-1 to 130-x may communicate with a plurality of clients over network protocols such as Network File System (NFS) and Server Message Block (SMB).

Some of the processes running over nodes 130-1 to 130-x may include file system daemons (FSDs) 170-1 to 170-x. Each of nodes 130-1 to 130-x may include one or more FSDs which serve as containers for services and effectively control files in distributed file server 120.

Files in distributed file server 120 are distributed across FSDs 170-1 to 170-x and across nodes 130-1 to 130-x. Distributed file server 120 may also include file servers 140-1 to 140-x in at least one of nodes 130-1 to 130-x, wherein each of file servers 140-1 to 140-x may receive file system connect requests 112 from clients such as client machine 110.

Upon receiving such a connect request 112, file servers 140-1 to 140-x refer the requests to one of FSDs 170-1 to 170-x that holds the required file. Once a client connects to a file, a session is created for the opened file. The administrator of the file system may need to know, from time to time, which files are open and which sessions are taking place.

In many file systems known in the art, an administrator can issue an enumeration operation on a file system and receive in return a list of all sessions and/or open files. This list is required in order to better manage the usage of the files on the files system by client and address various problems.

After reviewing the list, the administrator may close suspicious files opened by specific clients, and monitor existing sessions. One important requirement is that the enumeration reflects the most updated status of sessions and open files of the file system.

In large-scale, distributed file systems, the enumeration process becomes extremely challenging due to the high volume of session and open files. A typical large scale file system manages thousands of users' sessions and millions of file handles at every single moment.

As a consequence, file and sessions enumeration in large scale file systems suffer from high latency as well as high CPU usage. This leads to ineffective enumeration process that does not yield an updated status of the sessions because sessions keep being opened and closed by users before the enumeration process ever ends. Additionally, very often the enumeration process takes longer than the timeout limit of system and the enumeration request does not even provide any meaningful feedback.

In many cases, when applied to currently available file systems, the enumeration request fails due to timeouts when trying to enumerate large amount of data, and the administrator cannot operate of the opened resources.

Additionally, the enumeration process by itself affects the overall performance of the files system because, at the current architecture of file systems known in the art, the enumeration request requires nodes in a cluster to communicate with each other, marshalling each session/open-file, and returning the data via a remote procedure call (RPC) to the external listener. This may be implemented using a management console or an appropriate user interface. An exemplary management console is the Microsoft Management Console (MMC) which is a component of the Windows operating system that provides system administrators and advanced users an interface for configuring and monitoring the system.

Current file systems known in the art only enable a full and complete enumeration of the files or sessions. This means that any enumeration request causes the enumeration of the entire set of sessions and/or opened-files in the file system cluster. Additionally, in the current architecture, the enumeration request invokes a lot of inter-node communication of data which tend to cause a bottle-neck of its own.

Consequently, currently available file systems tend to hang up from few minutes to few hours when an enumeration request is issued on high load. File access itself might be affected and slowed down, and in such a case, management console might return with a time-out error even before the actual enumeration data has been received.

Furthermore, displaying the information about established SMB/NFS sessions, connections or opened-files for example, may take up to an hour to complete when the system in overloaded with traffic. In this case, presenting client's activity and resources are not feasible or useable for administrators.

### SUMMARY OF THE INVENTION

Some embodiments of the present invention provide a method for carrying out filtered enumeration of files and sessions in a file system. The method may include: sending a filtered enumeration request from a client machine to a file system server which include a distributed cluster of nodes, wherein the filtered request indicates subsets of sessions and files metadata; applying, at the file system server, the filtered enumeration request at each of the nodes; aggregating the sessions and files metadata of the filtered enumeration request; and sending the aggregated filtered sessions and files metadata back to the client machine. The system according to some embodiments of the present invention implements the aforementioned method over a distributed file server. More specifically, the system in accordance with embodiments of the present invention implements the aforementioned method on a server side of the file system.

According to some embodiments of the present invention, the filtered enumeration request may be capped at a maximal number of resources to be returned in the aggregated filtered sessions and files metadata.

According to some embodiments of the present invention, the aggregation may be carried out by repeatedly sending the filtered enumeration request between adjacent nodes until all subsets of files and sessions of the request are enumerated.

According to some embodiments of the present invention, the filtering of the filtered enumeration request may relate to at least one of: names of files; users who opened files; duration of sessions; and duration of idle periods in sessions.

According to some embodiments of the present invention, the filtering of the filtered enumeration request may be carried out semi automatically based on administrator preferences and file system performance.

According to some embodiments of the present invention, the filtered enumeration request is generated at the client machine side by a decision support interface, based on administrator requirements.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a file system in accordance with embodiments of the prior art;

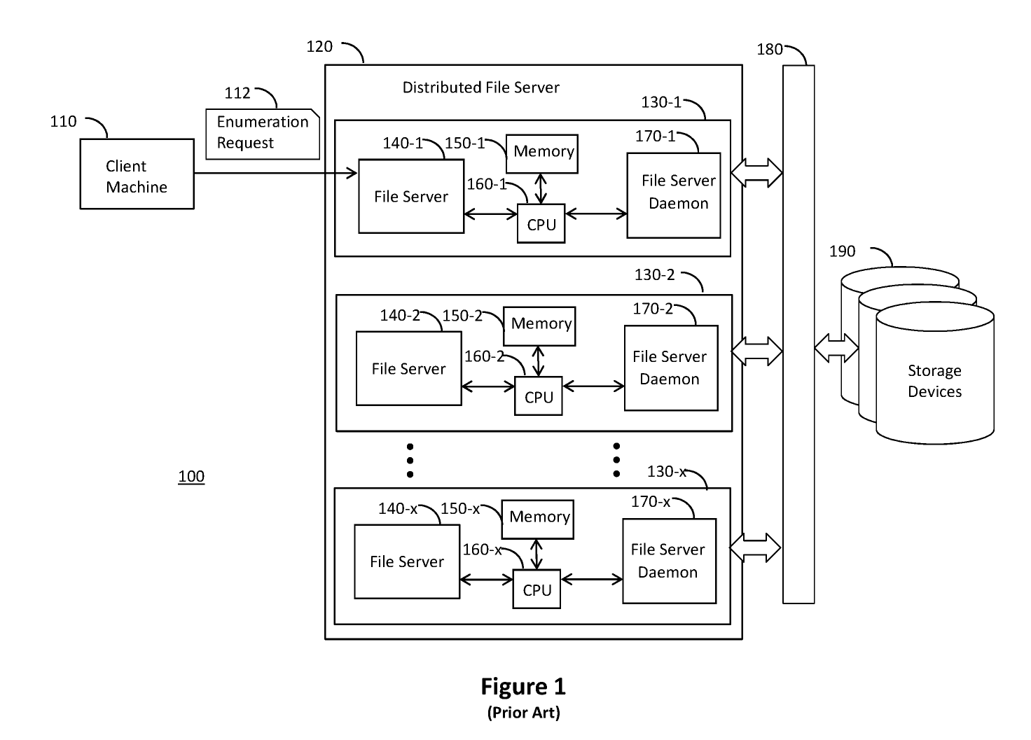

FIG. 2 is a block diagram illustrating non-limiting exemplary architecture of a file system in accordance with embodiments of the present invention; and

FIG. 3 is a high level flowchart illustrating non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In order to address the drawbacks of the prior art, embodiments of the present invention are aimed at changing the basic paradigm of a comprehensive enumeration process carried out on all resources on the file system and to apply a filter-based approach that is implemented on the server side. The suggested approach of embodiments of the present invention enables the administrator to receive an updated, informative and significant image on current users' activity, even when cluster is handling hundreds of thousands of resources all at once. The assumption behind the filter-based approach is that not all data relating to session and files opened is equally important for the administrator in order to better manage the file system.

By applying a filer-based approach, even with over a million opened-files served by the file system, the administrator can be provided with the top valuable information of sessions, connections and opened-files. The filtered enumeration process only lasts a few seconds without significantly affecting the overall performance of the file system.

Implementing the filter-based approach needs to be on server-side and cannot be effectively implemented on the UI/client-side.

The reason is that as explained above, enumeration process invokes a lot of inter-node communication such as marshalling all sessions/files data and sending hundreds of thousands records within the cluster.

It is therefore suggested that the file-system itself poses a limit on the number of records returned to the client when using filtering, collecting from each node the filtered information.

In accordance with embodiments of the present invention the aforementioned filter module may be located on each node of the file system.

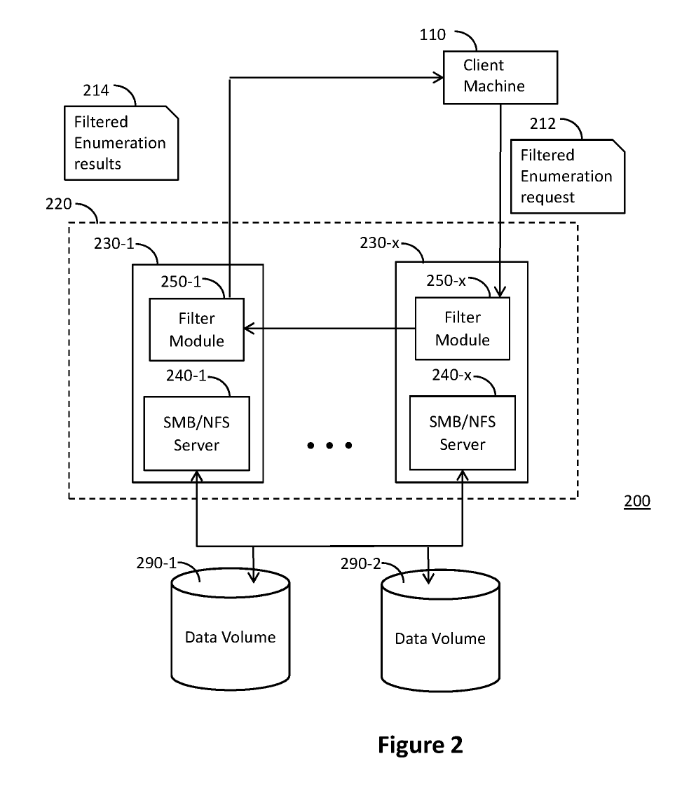

FIG. 2 is a block diagram illustrating non-limiting exemplary architecture of a file system in accordance with embodiments of the present invention. System 200 includes a client machine 110 configured to send a filtered enumeration request 212, wherein the filtered request indicates subsets of sessions and files metadata. System 200 further includes a distributed file system server 220 which includes a distributed cluster of nodes 230-1 to 230-x, each having a respective filter module 250-1 to 250-x configured to: apply the filtered enumeration request at each of the nodes; aggregate the sessions and files metadata of the filtered enumeration request; and send the filtered enumeration results 214 which includes filtered sessions and files metadata back to the client machine.

In other words, each of filter module 250-1 to 250-x is configured to aggregate the sessions and files metadata of the filtered enumeration request from previously enumerated nodes, wherein the filter module which is last to apply the filtered enumeration request is configured to send the aggregated filtered sessions and files metadata (filtered enumeration results 214) back to client machine 110.

According to some embodiments of the present invention, the filtered enumeration request is capped at a maximal number of resources to be returned in the aggregated filtered sessions and files metadata.

According to some embodiments of the present invention, the aggregation is carried out by repeatedly sending the filtered enumeration request between adjacent nodes until all subsets of files and sessions of the request are enumerated.

According to some embodiments of the present invention, the filtering of the filtered enumeration request relate to at least one of: names of files; name of users that have opened the files; duration of session; duration of idle period in sessions.

According to some embodiments of the present invention, the generating of the filtered enumeration request is carried out semi automatically via a user interface on the client side, based on administrator preferences and file system performance.

According to some embodiments of the present invention, the filtered enumeration request is generated at the client machine side by a decision support interface, based on administrator requirements.

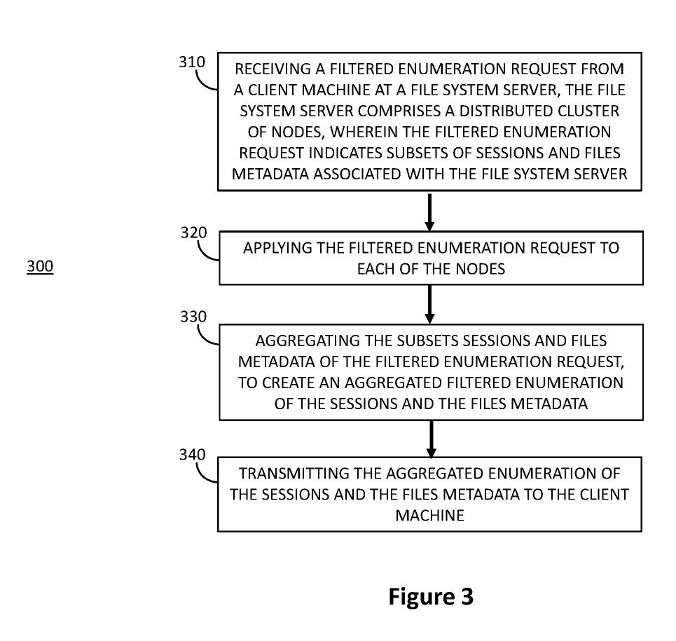

FIG. 3 is a high level flowchart illustrating non-limiting exemplary method in accordance with embodiments of the present invention. Method 300 may include: receiving a filtered enumeration request from a client machine at a file system server, the file system server comprises a distributed cluster of nodes, wherein the filtered enumeration request indicates subsets of sessions and files metadata associated with the file system server 310; applying the filtered enumeration request to each of the nodes 320; aggregating the subsets sessions and files metadata of the filtered enumeration request, to create an aggregated filtered enumeration of the sessions and the files metadata 330; and transmitting the aggregated enumeration of the sessions and the files metadata to the client machine 340.

Following is an illustrative non-limiting example for a filtered-enumeration process that may be implemented by a file system, having four nodes in the cluster. In such an example, each node may be limited to return maximum 1000 sessions/opened-files records if one of the following filters are used:

file-name <file name to include>

min-idle-time <minimum session idle time in minutes>

min-opened-files <minimum opened files in session>

user-name <the user name who established the session>

Each node then has to go over its local record of sessions/opened-files, include only the items matching the filters above, and stop enumerating when reach its limit.

Since the filters have been designed to retrieve data on more interesting scenarios rather than simply all files or sessions, the administrator receives the most valuable information within only few seconds.

While designing a filter it should be guaranteed that the node should not enumerate more than ˜1000 resources (files/sessions) at a single request that comes with a filter. The motivation for this limitation is protect the client when its filter actually matches all resources (being a worst-case scenario, from performance perspective). In that case, the filter isn't really giving any benefit, and if all resources are returned, the clients user interface (UI) is held for hours as well. So if each node always returns up to 1000 resources, its response is sent rather fast (approximately 1-2 seconds). It is understood that the number 1000 is merely a rule of thumb and is derived from current performance and in general a cap can be specified on a per case basis based on the aforementioned guidelines.

The flow of the filtered enumeration process within the file system is as follows: the filtered enumeration request is first being processed by filter module located on the first node in the file-system cluster. In response to the filtered request, the first node enumerates all matched items that are relevant to the domain it controls, and sends the filtered enumeration request, together with the enumeration results relevant to the domain controlled by the first node directly to the filter module located on the second node in the cluster. The filter module of the second node carries out a similar local enumeration for the relevant domain of files of the second node, and then sends the filtered enumeration request, together with the enumeration results of the first and the second node to the filter module located on the third node, where the process of filtered, node- specific enumeration process is applied, and so forth.

After all nodes have enumerated the resources according the filter, (and skipped all un-matched filter objects) the last node at the cluster sends the aggregated enumeration result of all nodes back to the client machine.

Advantageously, by using the aforementioned filter mechanism that is calculated on server side, much of the internal node-to-node traffic is being eliminated.

In accordance with embodiments of the present invention, a non-transitory computer readable medium may include a set of instructions that when executed cause at least one processor to: send a filtered enumeration request from a client machine to a file system server which include a distributed cluster of nodes, wherein the filtered request indicates subsets of sessions and files metadata; apply, at the file system server, the filtered enumeration request at each of the nodes; aggregate the sessions and files metadata of the filtered enumeration request; and send the aggregated filtered sessions and files metadata back to the client machine.

In accordance with embodiments of the present invention, the non-transitory computer readable medium may further include a set of instructions, when executed, further cause the least one processor to implement the filter that has been designed on an ad hoc basis.

In order to implement the method according to embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of carrying out a filtered enumeration of files and sessions in a file system, the method comprising:
receiving a filtered enumeration request from a client machine at a file system server, the file system server comprises a distributed cluster of nodes, wherein the filtered enumeration request indicates subsets of sessions and files metadata associated with the file system server;
applying the filtered enumeration request to each of the nodes;
aggregating the subsets sessions and files metadata of the filtered enumeration request, to create an aggregated filtered enumeration of the sessions and the files metadata; and
transmitting the aggregated enumeration of the sessions and the files metadata to the client machine.

2. The method according to claim 1, wherein the filtered enumeration request is capped at a maximal number of resources to be returned in the aggregated filtered sessions and files metadata.

3. The method according to claim 1, wherein the aggregation is carried out by repeatedly sending the filtered enumeration request between adjacent nodes until all subsets of files and sessions of the request are enumerated.

4. The method according to claim 1, wherein the filtering of the filtered enumeration request relates to at least one of: names of files; users who opened files; duration of sessions; and duration of idle periods in sessions.

5. The method according to claim 1, wherein the filtering of the filtered enumeration request is carried out semi automatically based on administrator preferences and file system performance.

6. The method according to claim 1, wherein the filtered enumeration request is generated at the client machine side by a decision support interface, based on administrator requirements.

7. A system for carrying out a filtered enumeration of files and sessions in a file system, the system comprising:
a file system server comprising a distributed cluster of nodes configured to receive a filtered enumeration request from a client machine at a file system server, wherein the filtered enumeration request indicates subsets of sessions and files metadata associated with the file system server;
a plurality of filter modules being processes running on respective nodes, configured to apply the filtered enumeration request to the nodes;
wherein each of the filter modules is configured to aggregate the subsets sessions and files metadata of the filtered enumeration request of a preceding node, to create an aggregated filtered enumeration of the sessions and the files metadata, and
wherein the filter module that aggregates all enumerations from preceding nodes is configured to transmit the aggregated enumeration of the sessions and the files metadata to the client machine.

8. The system according to claim 7, wherein the filtered enumeration request is capped at a maximal number of resources to be returned in the aggregated filtered sessions and files metadata.

9. The system according to claim 7, wherein the aggregation is carried out by repeatedly sending the filtered enumeration request between adjacent nodes until all subsets of files and sessions of the request are enumerated.

10. The system according to claim 7, wherein the filtering of the filtered enumeration request relates to at least one of: names of files; users who opened files; duration of sessions; and duration of idle period in sessions.

11. The system according to claim 7, wherein the filtering of the filtered enumeration request is carried out semi automatically based on administrator preferences and file system performance.

12. The system according to claim 7, wherein the filtered enumeration request is generated at the client machine side by a decision support interface, based on administrator requirements.

13. A non-transitory computer readable medium comprising a set of instructions that when executed cause at least one processor to:
receive a filtered enumeration request from a client machine at a file system server, the file system server comprises a distributed cluster of nodes, wherein the filtered enumeration request indicates subsets of sessions and files metadata associated with the file system server;
apply the filtered enumeration request to each of the nodes;
aggregate the subsets sessions and files metadata of the filtered enumeration request, to create an aggregated filtered enumeration of the sessions and the files metadata; and
transmit the aggregated enumeration of the sessions and the files metadata to the client machine.

14. The non-transitory computer readable medium according to claim 13, wherein said set of instructions, when executed, further cause said at least one processor to cap a maximal number of resources to be returned in the aggregated filtered sessions and files metadata.

15. The non-transitory computer readable medium according to claim 13, wherein said set of instructions, when executed, further cause said at least one processor to repeatedly send the filtered enumeration request between adjacent nodes until all subsets of files and sessions of the request are enumerated.

16. The non-transitory computer readable medium according to claim 13, wherein the filtering of the filtered enumeration request relate to at least one of: names of files; users who opened files; duration of sessions; and duration of idle periods in sessions.

17. The non-transitory computer readable medium according to claim 13, wherein the filtering of the filtered enumeration request is carried out semi automatically based on administrator preferences and file system performance.

18. The non-transitory computer readable medium according to claim 13, wherein the filtered enumeration request is generated at the client machine side by a decision support interface, based on administrator requirements.
